(19) United States
(12) Patent Application Publication
(10) Pub. No.: US 2025/0024821 A1
(43) Pub. Date: Jan. 23, 2025

(54) FACILITY FOR THE AQUACULTURE OF ANIMAL SPECIES

(71) Applicant: Lisaqua, Nantes (FR)

(72) Inventor: Charlotte Schoelinck, Nantes (FR)

(21) Appl. No.: 18/713,893

(22) PCT Filed: Nov. 28, 2022
(86) PCT No.: PCT/EP2022/083428

§ 371 Date: May 28, 2024

(30) Foreign Application Priority Data
Nov. 26, 2021 (FR) 2112602

(51) Int. Cl. A01K 63/04; A01G 33/00; A01K 61/10; A01K 61/51; A01K 61/59

(52) U.S. Cl. CPC A01K 63/045; A01G 33/00; A01K 61/10; A01K 61/51; A01K 61/59

(57) ABSTRACT

A facility for the aquaculture of a first animal species that consumes protein and produces waste containing urea and nitrogenous sludge, includes: a hatchery comprising at least one clean-water laying tank, at least one clean-water hatching tank, and at least one clean-water larva tank; at least one clean-water pre-maturation tank and maturation tank, with means for supplying protein-rich feed; and at least one rearing tank containing water and biofloc containing bacteria that carry out nitrification of the waste. The facility further comprises: at least one second rearing tank for rearing a second animal species that acts as a biofilter for nitrogenous products; means for transferring the nitrogenous sludge that has accumulated in the first rearing tanks to the second rearing tanks; and means for transforming the species of the second species into feed protein and for transferring it to the pre-maturation and maturation tanks.

### CROSS-REFERENCE TO RELATED APPLICATIONS

This application is a national phase entry under 35 U.S.C. § 371 of International Patent Application PCT/EP2022/083428, filed Nov. 28, 2022, designating the United States of America and published as International Patent Publication WO 2023/094646 A1 on Jun. 1, 2023, which claims the benefit under Article 8 of the Patent Cooperation Treaty of French Patent Application Serial No. FR2112602, filed Nov. 26, 2021.

### TECHNICAL FIELD

The present disclosure relates to the field of integrated aquaculture production systems, particularly for shrimp production.

### BACKGROUND

Integrated multi-trophic aquaculture is a sustainable way of producing aquatic feed. This technique involves incorporating the foundations of a natural food chain or web into the system, to ensure better conservation of the environment while at the same time ensuring intense feed production. This is a more sustainable way of cultivating aquatic organisms such as fish, mollusks and marine plants for consumption. The organisms are chosen so that each species present provides at least one benefit for another species, thus artificially recreating a system found in nature, that is, a food web.

In the state of the art, International Patent Application Publication No. WO2015105523A1 discloses an automated, high efficiency aquaponics system that combines conventional cultivation techniques with hybrid integrated multi-trophic aquaculture and aeroponics, using a microalgae bioreactor and organism reactor production system. This known solution uses biomeasurements and adaptive measurements, as well as thermal imaging analysis, for monitoring and control by robotic automation using an intelligent control system. The control system ensures a controlled symbiotic environmental ecosystem.

Also known is U.S. Pat. No. 4,250,835, which relates to a system for recirculating food deposited at the bottom of a larva tray through the rearing medium of the larva tray. The apparatus includes a first conduit means positioned in the rearing medium with an inlet located near the bottom of the larva tray; a second conduit means in fluid communication with the first conduit means with a discharge outlet located near the surface of the rearing medium, and shaped such that the force of discharge from the discharge outlet has a component parallel to the surface of the rearing medium and perpendicular to a line radiating from its geometric center; and pumping means for moving a mixture of decanted feed and rearing medium from the bottom of the larva tray through the first conduit means and the second conduit means to the discharge outlet of the second conduit means. The discharge of the mixture from the discharge outlet into the rearing medium imparts a circular flow to the medium.

Also known is U.S. Patent Application Publication No. 2014/061124, which relates to an effluent treatment method and facility. The treatment comprises at least one passage of the effluent through a device for biological pretreatment of the effluents, such as a bacterial bed, a lagoon or a biological disc, at least one nitrification-denitrification of the pretreated effluents resulting from the biological pretreatment device, using a vertical-flow filter planted with rhizome plants, e.g., reeds, a lower zone of which is flooded and an upper zone of which is unflooded, and means for injecting coagulants capable of precipitating the phosphates of effluents, e.g., ferric chloride salts.

Also known is U.S. Patent Application Publication No. 2015/144069, which relates to a system and method for producing a fully organic soil enhancement material product that comprises a wastewater byproduct from fish farming operations and common soil microbiology, prepared and delivered according to a carefully controlled method, which significantly increases plant health and growth while simultaneously reducing the need to apply synthetic chemicals for nutrients, pests and disease.

Prior art solutions do not allow for the creation of a fully controlled aquaculture production facility producing minimal waste and operating in a stable and reproducible manner on a single site, on an industrial scale.

### BRIEF SUMMARY

In order to address these drawbacks, the present disclosure relates, in its most general sense, to an aquaculture facility.

For the purposes of this patent, “facility” means a single production site, for example, abuilding. In accordance with an embodiment of the present disclosure, such a facility comprises:
a first series of equipment for laying, hatching and larva rearing, comprising rearing tanks for a first animal species, and
a series of equipment for laying, hatching and larva rearing, comprising rearing tanks for a second animal species.

The facility may, for example, include prawn and worm hatcheries, or include only prawn and invertebrate rearing equipment, the hatcheries being installed on another site separate from the facility and supplying the facility with prawn and worm larvae.

Preferably, the facility comprises a settling tank for treating the liquids from the rearing tanks to separate:
the nitrogen-rich supernatant, which is transferred to a biofilter tank containing bacteria that carry out nitrification, the biofilter outlet comprising a three-way valve including:
a first port connected to a denitration device whose outlet is connected to the settling tank;
a second port connected to the rearing tank;
a third port for emptying and cleaning operations; and
wherein the (nitrogen-rich) sludge is transferred to the rearing trays.

According to an advantageous variant, the facility comprises a tank for sequential collection and sedimentation of fractions of the liquids contained in the hatchery, pre-maturation and maturation tanks and trays, and for separating the liquid phase from the solid phase, featuring a valve for evacuating the solid phase, then transferring the residual liquid phase for reinjection into the rearing tanks and/or the rearing trays.

According to another variant, the facility further comprises means for treating the liquid phase, comprising a mechanical filter, a biological filter and a UV filter, as well as a buffer tank connected to the rearing tanks and/or the rearing trays.

### BRIEF DESCRIPTION OF THE DRAWINGS

Other features and advantages will become apparent from the following description of the present disclosure, given only by way of example, referring to the accompanying drawings in which:

FIG. 1 is a schematic block diagram the functional architecture of a facility according to the present disclosure;

FIG. 2 is a schematic depiction of the process for treating the supernatant from the settling tank originating from the rearing tanks;

FIG. 3 is a schematic depiction of the process for treating the supernatant from the settling tank originating from the rearing trays;

FIG. 4 is a schematic depiction of the process of reclaiming prawn sludge;

FIG. 5 is a schematic depiction of the process of storing and reclaiming process water; and

FIG. 6 is a depiction of the prawn life cycle.

### DETAILED DESCRIPTION

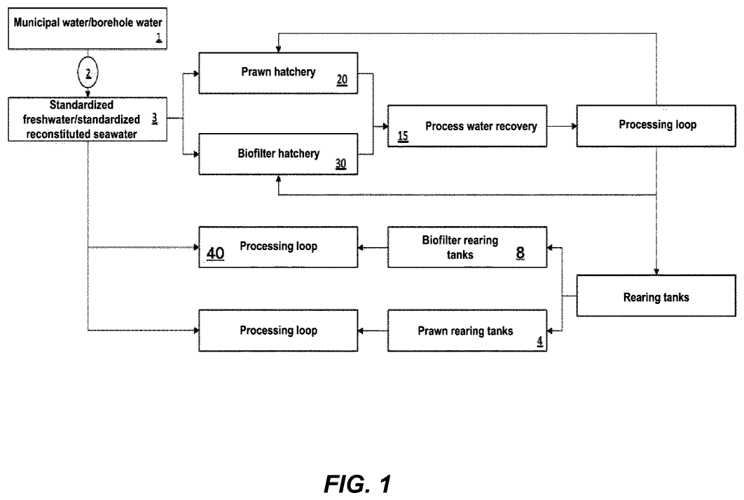

FIG. 1 shows a schematic view of an on-site prawn rearing facility according to the present disclosure, designed to produce prawns in an artificial environment recreating mangrove rearing conditions, with strictly reduced effluents, by co-cultivating several species consuming the droppings of other species in the facility to produce materials serving as food for other species in the closed ecosystem thus created. The aim is to reduce the inputs and effluents of such a facility, notably the water from a municipal water supply (1) or borehole water.

The principle of the present disclosure is based on the co-cultivation of two animal species:
a. the first marine animal species being
   intended for human food consumption, in particular, shellfish or fish;
   and being fed, at least at certain stages of its reproduction and rearing cycle, with proteins from animals of the second species. Typically, before laying, breeding animals of the first species are fed animals of the second species, either directly or after slaughter and possible processing into protein paste.
b. the second animal species being:
   intended for feeding the first co-produced animal species, in particular, breeding animals of the first species, possibly with an additional reclaiming of the surplus of animals of the second animal species for animal feed or for the production of other protein-rich materials, for example, worms or baits for fishing;
   this second animal species being further characterized by the fact that it feeds on material originating from the solid droppings of the first animal species; and
   this second animal species, in particular, consisting of scavenger animals, in particular, aquatic and preferably marine worms.

The culture medium for the first marine animal species consists of seawater, in particular, reconstituted seawater, containing rearing sludge provided by seeding from previous rearing, this rearing sludge containing nitrifying bacteria. A biofloc condensate is added to this culture medium. The addition of elements such as urea, protein-rich food and sugar helps bacterial colonies to develop. These bacterial colonies will digest the residual food of the animals of the first species (droppings, uneaten food, etc.).

The metabolism of the animals of the first species, for example, shrimp, leads to the production of rejections:
of urea (nitrogen excretions from animals) degraded by autotrophic nitrifying and/or heterotrophic bacteria and, more generally, mixotrophic bacterial colonies, with a transformation cycle by microalgae with the NH₄⁺ cycle to NO₂⁻ and then to NO₃⁻; and
of feces decompose into dissolved matter and solid particulate residues forming sludge, which can be reused to reseed new culture media containing bacteria and micro-algae.

The shrimp thus produce:
dissolved waste, potentially toxic to shrimp, which feeds the bacteria and micro-algae present in the culture medium; and
solid waste, suitable for feeding the animals of the second species, especially worms.

### Rearing of the Breeding Animals

The mating, spawning, hatching and rearing stages are carried out by moving the adult breeding animals between various tanks, containing reconstituted seawater and supplies of rich food, consisting of animals of the second species, directly when they are of a size suitable for consumption by breeding animals of the first species, or otherwise cut up and optionally processed into protein pastes, for example. Once the females are pregnant, they are moved from their mating or brood tray to a laying tank, where they deposit their eggs. These eggs are expelled into reconstituted seawater, then collected by filtration.

### Water Circuit

The site's water circuit is supplied periodically from the municipal water supply (1) or from a borehole to top up the volume of circulating water, with a flow rate controlled by a servo-valve (2) whose outlet is connected to a freshwater and saltwater treatment system (3) ensuring that the characteristics of the freshwater and saltwater circulating in the facility remain constant. The servo-valve (2) is controlled to restore the water volume and compensate for losses due to evaporation, for example.

### Water Circuit

The water circuit from the freshwater and saltwater treatment system (3) supplies a first series of facilities comprising a prawn hatchery (20) and a biofilter-forming invertebrate hatchery (30). Process water is recovered (15), reprocessed and reintroduced into the prawn hatchery (20) and invertebrate hatchery (30) facilities, the prawn-rearing tanks (4) and the invertebrate trays (X).

The facility comprises a first tank for rearing prawns (4). This prawn-rearing tank (4) contains saltwater and bacterial flocs.

The aim of the floc technique is to optimize the quality of breeding animals while limiting pressure on the environment by reducing water use and, as a result, the discharge of rearing waste to the outside world. In addition, the floc complements the prawns' diet, reducing the amount of added food. The floc consists mainly of bacterial elements, notably nitrifying bacteria, and micro-algae.

The prawn-rearing tank (4) undergoes permanent mechanical agitation to ensure aeration and oxygenation, floc recirculation and good floc distribution throughout the tank. Typically, the tank contains around 300 g of flocculated biomass per cubic meter. The tank can be equipped with lighting and/or shading control means to adjust light energy based on the photosynthesis needs of the micro-algae and to avoid excessive proliferation leading to oxygen depletion.

Prawn farming generates effluents in solid or soluble form. Waste is essentially made up of uneaten food, feces (the non-digestible part of food) and excretion products (the end products of the metabolic utilization of the digestible part of ingested nutrients). The volume of waste is significant, around 150 kg of dry matter, including 50 kg of nitrogen and 8 kg of phosphorus for one ton of prawns produced.

The tank (8) operates in clean water; it can be made up of several tanks for separate rearing of the breeding animals, hatching and maturing of prawns.

The water in the prawn-rearing tank (4) is continuously treated by a processing loop (40). This processing loop (40) contains the decanter (5), biofilter (6) and denitration device (7).

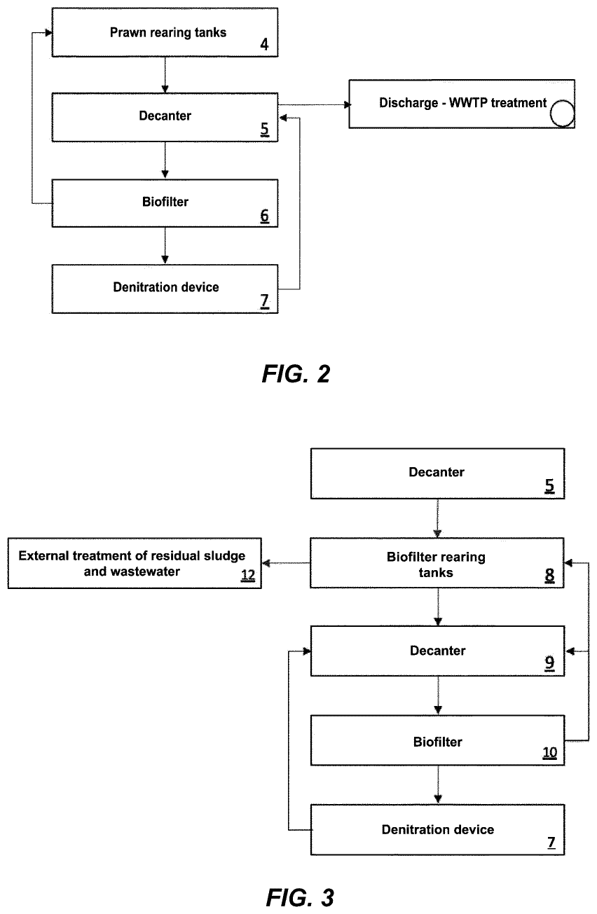

As shown in FIG. 2, the water in the prawn-rearing tank (4) is continuously treated by removing a portion of the contents, for which the heavy particles and the liquid are then separated in a decanter (5). The nitrite-rich supernatant, containing the nitrogenous matter, is transferred to a biofilter (6) for nitrogenous matter transformation. The nitrate-rich water is treated by a denitration device (7), which acidifies the water before reinjection into the decanter (5).

The sludge, rich in nitrogen and phosphorus, is dried and disinfected to serve as food for the invertebrates in the biofilter-rearing tank (8).

Waste (feces, food scraps, etc.) is progressively degraded by micro-organisms present in the floc, containing various aerobic bacteria that metabolize organic nitrogen into ammoniacal nitrogen (minerals) and various nitrogenous metabolites. Ammoniacal nitrogen is then transformed into nitrite by autotrophic bacteria of the Nitrosomonas genus, notably Nitrosomonas europeae. Nitrites are then converted to nitrates by Nitrobacter bacteria in the biofilter (6) attached to a bacterial support such as curler-type biofiltration media, crushed pozzolan or porous ceramic.

Denitrification is then carried out by bacteria such as Pseudomonas, Flavobacterium, Alcaligenes, Achromobacter, Escherichia, Micrococcus, etc., using the enzyme Nitrate reductase A to convert nitrates into dinitrogen, which is then transferred to the decanter (5).

Sludge from the decanter feeds an invertebrate feed tank, for example, for worms, which are reared in a biofilter-rearing tank (8) to prepare food for breeding prawns reared in the hatchery (20). If necessary, freshwater is added to the biofilter-rearing tank (8). Invertebrates are fed continuously by dried sludge from the decanter (5).

Treatment of Supernatant from the Prawn-Rearing Tank

FIG. 2 shows the processing loop for animals of the first species (prawns, for example). The liquid from the prawn-rearing tank (4) is transferred to the decanter (5), which receives this low-nitrate, low-alkaline effluent. The nitrite-rich supernatant is transferred to a biofilter (6), while the mineral-poor water is discharged for treatment in a wastewater treatment plant.

Treatment of the Supernatant from the Biofilter-Rearing Trays

FIG. 3 shows the invertebrate processing loop. The liquid from the biofilter-rearing tank (8) is transferred to the decanter (9), which receives this low-nitrate, low-alkaline effluent. The nitrite-rich supernatant is transferred to a biofilter (10), while the mineral-poor water is discharged for treatment in a wastewater treatment plant (12).

### Recovery of Prawn Sludge

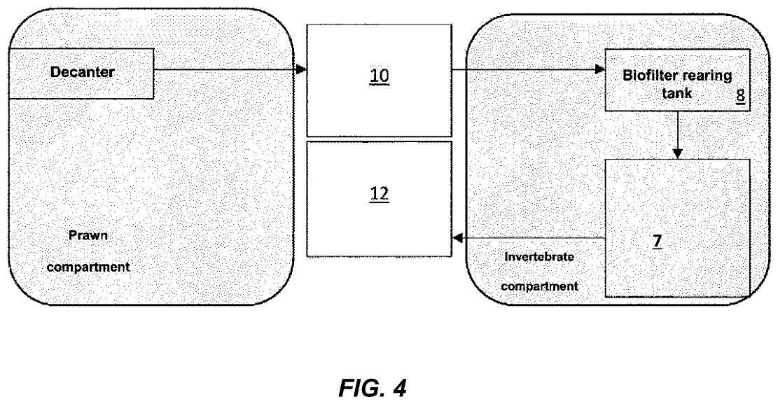

FIG. 4 shows the process for reclaiming prawn sludge from the decanter (5). This sludge contains 90% water and solids rich in particulate nitrogen and phosphorus. They undergo a drying and disinfection stage to produce a dry material, containing around 30% residual moisture rich in particulate nitrogen and phosphorus, which forms the nutrient base for invertebrates in the biofilter rearing tank (8). Invertebrate sludge and residual water low in particulate nitrogen and phosphorus are periodically recovered in the biofilter rearing tank (8), before being extracted and treated externally.

### Process Water Storage and Reclamation

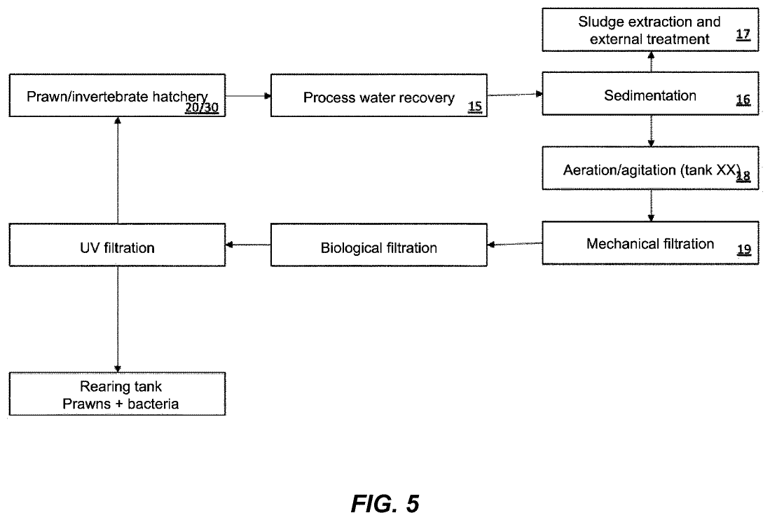

FIG. 5 shows the process of storing and reclaiming process water from a prawn hatchery (20) as well as an invertebrate hatchery (30). Water from both tanks is recovered (15) by a pipe leading into a sedimentation tank (16). This supernatant flows into a stirred tank (18), and the sludge is treated in a station (17). The residual water undergoes an initial mechanical filtration (19), biological treatment in a biofilter (21) followed by ultraviolet radiation treatment in a station, and is then supplied to the prawn-rearing tank (4), the invertebrate rearing tank (8), the prawn hatchery and the invertebrate hatchery.

### Prawn Growth

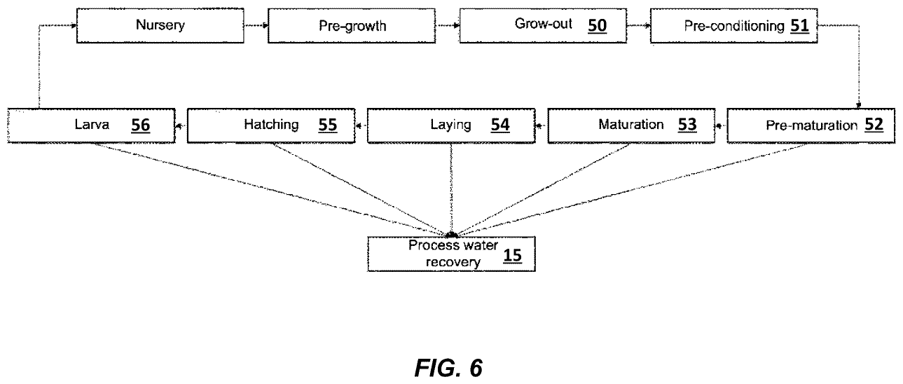

FIG. 6 shows the prawn production cycle, which can take place by passing through a succession of tanks supplied by water from the site.

The cycle comprises stages for nursery, pre-growth, grow-out (50), preconditioning (51), pre-maturation (52), maturation (53), laying (54), hatching (55) and growth of the larvae (56), which are then returned to the nursery phase.

The water from the various tanks is recovered and subjected to sedimentation treatment, sludge extraction and treatment, and filtration as disclosed above.

### Rearing Tanks for Animals of the First Species

The rearing tanks for the first species, in particular, shrimp, are advantageously divided into three tanks corresponding to increasing stages of maturity.

Each tank is optionally equipped with a turbidity sensor and a temperature sensor.

The first tank is the nursery. It has a smaller volume than the other tanks. It has a spigot at the bottom for gravity transfer to the next tank, which is located at a lower level. The tank can comprise a hydroacoustic and/or optical sensor for counting the number of shrimp. The spigot system optionally comprises an optical system for counting the number of shrimp transferred.

The next two tanks comprise an automatic supply system, such as a protein granule discharge hopper.

Optionally, they comprise movable nets to prevent shrimp from crossing the edge of the tank, which nets can be raised to facilitate access to the tank, particularly for animal sampling.

A transfer valve is installed between the pre-growth and grow-out tanks for gravity transfer between the two tanks.

### Rearing Tanks for Animals of the Second Species

The rearing of the animals of the second species involves several stages: maturation of the breeding animals, laying, hatching and larva rearing. The larvae are then sent to production sites that can be set up on other sites.

1. A facility for the aquaculture of a first animal species that consumes protein and produces waste containing urea and nitrogenous sludge, comprising:
a hatchery comprising at least one clean-water laying tank, at least one clean-water hatching tank, and at least one clean-water larva tank;
at least one clean-water pre-maturation tank and at least one maturation tank, with means for supplying protein-rich feed; and
at least one first rearing tank for the first animal species containing water and biofloc containing bacteria that carry out nitrification of the waste;
at least one other rearing tank for a second animal species, the second animal species acting as a biofilter for nitrogenous products;
means for transferring the nitrogenous sludge that has accumulated in the first rearing tanks to the at least one other rearing tank; and
means for transforming the species of the second animal species into feed protein, and for transferring the feed protein to the at least one pre-maturation tank and the at least one maturation tank.

2. The aquaculture facility of claim 1, further comprising a settling tank for treating liquids of the at least one first rearing tank and the at least one other rearing tank to separate:
supernatant, which is transferred to a biofilter tank containing bacteria that carry out nitrification, the biofilter tank comprising a three-way valve including:
a first port connected to a denitration device whose outlet is connected to the settling tank;
a second port connected to the rearing tank; and
a third port for emptying and cleaning operations;
sludge, which is transferred to the at least one first rearing tank and the at least one other rearing tank.

3. The aquaculture facility of claim 1, further comprising a tank for sequential collection and sedimentation of fractions of liquids contained in the at least one clean-water laying tank, at least one clean-water hatching tank, and at least one clean-water larva tank, and for separating a liquid phase from a solid phase, featuring a valve for evacuating the solid phase, then transferring the residual liquid phase for reinjection into the at least one first rearing tank and the at least one other rearing tank.

4. The aquaculture facility of claim 3, further comprising means for treating the liquid phase, comprising a mechanical filter, a UV filter, a biological filter, and a buffer tank connected to the at least one first rearing tank and the at least one other rearing tank.
